(19) United States
(12) Patent Application Publication
(10) Pub. No.: US 2017/0243524 A1
(43) Pub. Date: Aug. 24, 2017

(54) EXCHANGEABLE THREE-DIMENSIONAL WALLPAPER SETS

(71) Applicant: Yogi Carranza, Huntington Beach, CA (US)

(72) Inventor: Yogi Carranza, Huntington Beach, CA (US)

(21) Appl. No.: 15/437,146

(22) Filed: Feb. 20, 2017

Related U.S. Application Data
(60) Provisional application No. 62/297,313, filed on Feb. 19, 2016.

(51) Int. Cl. G09F 7/04; G09F 19/12; G09F 23/00; D21H 27/20; G09F 7/18

(52) U.S. Cl. CPC G09F 7/04; D21H 27/20; G09F 7/18; G09F 23/00; G09F 19/12; G09F 2007/1852; G09F 2007/1856; G09F 2007/186

(57) ABSTRACT

The present disclosure relates to wallpaper sets. In accordance with one embodiment of the present disclosure, a wallpaper set comprises a first piece of wallpaper detachable to a first metal frame, a second piece of wallpaper detachable to a second metal frame and a third piece of wallpaper detachable to a third metal frame; wherein the first metal frame, the second metal frame and the third metal frame are attached to three walls of a cubicle, room or office, and images of the first piece of wallpaper, second piece of wallpaper and third piece of wallpaper are designed in a way that they are visually connected with each other, making a user within the cubicle, room or office to feel physically being in an environment shown by the images.

### FIELD OF THE DISCLOSURE

The present disclosure generally relates to wallpaper sets. More specifically, the present disclosure discloses wallpaper sets that are easily exchangeable and are mounted to walls of a cubicle, room or office to make users feel like they are visually within the environment shown by the image(s) of wallpaper sets.

### BACKGROUND OF THE INVENTION

It is common for users to decorate walls of cubicles, homes or offices with wallpaper. The term “wallpaper” generally refers to rolls of sheets of a substrate onto which is printed a design. The substrate is not limited to paper, but can be any other type of sheet onto which print can be applied, and that will adhere to a wall surface, such as vinyl sheeting.

While conventional wallpaper can provide good aesthetic appearance for a room or office space, conventional wallpaper decorations can be limited by the repeating patterns that are required to allow alignment of similarly patterned sheets of wallpaper side by side on a wall. Conventional wallpaper decorations usually give monotonous impression with the repeated patterns and are also typically limited to the designs.

Further, conventional wallpapers usually attach to wall(s) using adhesives, making most of them single-use. Conventional wallpapers are un-useable after they have been removed and must be discarded. This inability to re-use wallpaper limits wallpaper-customization of walls and other surfaces which might be covered by wallpaper. Wallpaper installation, likewise, is made more difficult since once placed it is difficult to move, even slightly, for example to align a wallpaper pattern. In addition to the above, water-activated adhesive wallpaper installation is messy and requires purchase of adhesive, rollers, blades, etc.

Accordingly, there exists a need for wallpaper sets that are easy to install, modify, and customize. There also exists a need for wallpaper sets that provide users with enhanced visual impression.

### SUMMARY OF THE INVENTION

The embodiments of the present invention generally relate to wallpaper sets. More specifically, the present disclosure discloses three dimensional wallpaper sets that are easily exchangeable and are mounted to walls of a cubicle, room or office to make users feel like they are within the environment shown by the image of wallpaper sets.

In accordance with one aspect of at least one embodiment of the present disclosure, a wallpaper set is provided. The wallpaper set comprises: 1) a first piece of wallpaper detachable to a first metal frame, 2) a second piece of wallpaper detachable to a second metal frame, 3) a third piece of wallpaper detachable to a third metal frame; wherein the first metal frame, the second metal frame and the third metal frame are attached to at least three walls of a cubicle, room, or office; and images of the first piece of wallpaper, second piece of wallpaper and third piece of wallpaper are designed in a way that they are visually connected with each other, making a user within the cubicle, room or office to feel physically being in an environment shown by the images.

In addition, the image on the wallpaper can be three-dimensional and the wallpapers are magnetically connected to the metal frames, allowing the wallpapers to be exchanged or replaced easily. Such magnetically attachable wallpapers are also easy to install and remove.

These and other features, aspects and advantages of the present invention will become better understood with reference to the following drawings, description and claims.

### DETAILED DESCRIPTION OF THE PREFERRED EMBODIMENT(S) AND INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

Although the present invention has been described with respect to a specific preferred embodiment thereof, various changes and modifications may be suggested to one skilled in the art and it is intended that the present invention encompass such changes and modifications as fall within the scope of the appended claims.

Broadly, embodiments of the present disclosure generally provide three dimensional wallpaper sets that are easily exchangeable and are designed in a way that make users feel like they are visually within the environment shown by the image(s) of the wallpaper sets. In accordance with one embodiment of the present disclosure, a wallpaper set comprises: a first piece of wallpaper detachable to a first metal frame; a second piece of wallpaper detachable to a second metal frame; a third piece of wallpaper detachable to a third metal frame; wherein the first metal frame, the second metal frame and the third metal frame are attached to three walls of a cubicle, room or office; and images of the first piece of wallpaper, second piece of wallpaper and third piece of wallpaper are designed and arranged in a way that they are visually connected with each other, making a user within the cubicle, room or office to feel physically being in an environment shown by the images. For example, if the images of the wallpaper depict a forest, then the arrangement and design of the wallpaper set will make a user to feel like he or she is visually being in a forest. For better visual experience and impression, the wallpaper should cover full length of each wall.

In one embodiment of the present disclosure, the first piece of wallpaper is connected to the second piece of wallpaper at one edge and second piece of wallpaper is connected to the third piece of wallpaper at another edge.

Preferably, at least one of the images on the wallpaper sets is three-dimensional such as the images shown by FIGS. 1-3. The three-dimensional design greatly enhances users' visual impression and makes users feel more like physically being in the environment shown by the image (i.e., a forest, outer space or particular city) of the wallpaper. The three-dimensional images and designs are also customizable based on the user's needs.

In yet another embodiment of the present disclosure, the wallpapers are magnetically connected to the metal frames, allowing the wallpapers to be exchanged or replaced easily. Alternatively, other removable locking mechanism can also be used, such as clips, nails, adhesives (e.g., two sided tapes, heavy duty double side tape or any tape that is suitable for holding the wallpaper) or Velcro® tape (e.g., double sided Velcro® 2 or heavy duty Velcro® stripe). It is preferred that the wallpapers can be removed from the metal frames without using any tool so that the wallpapers are easily removable and can be taken to anywhere by the user.

When the wallpaper set is used on a room or office, the wallpaper set may optionally comprise a fourth piece of wallpaper detachable to a fourth metal frame, where the fourth metal frame is attached to the room or office's ceiling. The fourth piece of wallpaper is also connected to the first piece of wallpaper, the second piece of wallpaper and the third piece of wallpaper at three of its edges. Further, the wallpaper set may optionally comprise a fifth piece of wallpaper detachable to a fifth metal frame, where the fifth metal frame is attached to a side of wall not attached by the first, second, third or fourth metal frame. So that if a room or office has four walls and a ceiling, all of them will be covered by the wallpapers, which creates an even more visually appealing experience for users. The wallpaper may also comprise another sixth piece of wallpaper detachable to the floor or a carpet. Similarly, the images on the fourth, fifth and/or sixth pieces of wallpaper are also designed in a way that connect with the images of the first, second, third and fourth pieces of wallpapers.

In yet another embodiment of the present disclosure, walls of the cubicle, room or office are painted in gray or brown to enhance the image of the wallpapers.

In yet another embodiment of the present disclosure, the wallpaper for each wall or ceiling can be supplied in multiple sizes. Each sheet is configured to have a decorative design pattern formed thereon. The thickness of the wallpapers can be essentially any thickness, but it is preferable that they be of a thickness that makes them easily rollable and also cuttable using scissors.

Further, wallpapers are preferably made by reusable or recyclable materials such as paper. If the wallpaper contains metallic material, magnetic strip can be installed on the metal frames. The wallpaper can also be made with magnetic material to allow the wallpaper to magnetically attach to the metal frame. The metal frame can also be replaced by any magnetically attractive materials that are non-metallic.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A wallpaper set comprising:
a first piece of wallpaper detachable to a first metal frame;
a second piece of wallpaper detachable to a second metal frame;
a third piece of wallpaper detachable to a third metal frame;
wherein the first metal frame, the second metal frame and the third metal frame are attached to three walls of a cubicle, room or office; and
wherein images of the first piece of wallpaper, second piece of wallpaper and third piece of wallpaper are designed in a way that they are visually connected with each other, making a user within the cubicle, room or office to feel physically being in an environment shown by the images.

2. The wallpaper set of claim 1, wherein the first piece of wallpaper is connected to the second piece of wallpaper at one edge and second piece of wallpaper is connected to the third piece of wallpaper at another edge.

3. The wallpaper set of claim 1, wherein at least one of the first piece of wallpaper, second piece of wallpaper and third piece of wallpaper's image is three dimensional.

4. The wallpaper set of claim 1, wherein the first piece of wallpaper is attached to the first metal frame using magnetic or a locking mechanism that allows the first piece of wallpaper to be detached from the first metal frame without using any tool.

5. The wallpaper set of claim 1, wherein the second piece of wallpaper is attached to the second metal frame using magnetic or a locking mechanism that allows the second piece of wallpaper to be detached from the second metal frame without using any tool.

6. The wallpaper set of claim 1, wherein the third piece of wallpaper is attached to the third metal frame using magnetic or a locking mechanism that allows the third piece of wallpaper to be detached from the third metal frame without using any tool.

7. The wallpaper set of claim 1, further comprises a fourth piece of wallpaper detachable to a fourth metal frame, wherein the fourth metal frame is attached to the room or office's ceiling.

8. The wallpaper set of claim 7, wherein the fourth piece of wallpaper is connected to the first piece of wallpaper, the second piece of wallpaper and the third piece of wallpaper at three edges.

9. The wallpaper set of claim 1, further comprises a fifth piece of wallpaper detachable to a fifth metal frame, wherein the fifth metal frame is attached to a side of wall not attached by the first, second, third or fourth metal frame.

10. The wallpaper set of claim 1, wherein each piece of wallpaper covers full length of the wall.

11. A wallpaper set comprising:
a first piece of wallpaper detachable to a first metal frame;
a second piece of wallpaper detachable to a second metal frame;
a third piece of wallpaper detachable to a third metal frame;
wherein the first metal frame, the second metal frame and the third metal frame are attached to three walls of a cubicle, room or office;
wherein the first piece of wallpaper is connected to the second piece of wallpaper at one edge and second piece of wallpaper is connected to the third piece of wallpaper at another edge; and
wherein images of the first piece of wallpaper, second piece of wallpaper and third piece of wallpaper are designed in a way that they are visually connected with each other, making a user within the cubicle, room or office to feel physically being in an environment shown by the images.

12. The wallpaper set of claim 11, wherein the first piece of wallpaper is connected to the second piece of wallpaper at one edge and second piece of wallpaper is connected to the third piece of wallpaper at another edge.

13. The wallpaper set of claim 11, wherein the first piece of wallpaper, second piece of wallpaper and third piece of wallpaper's images are three dimensional.

14. The wallpaper set of claim 11, wherein the first piece of wallpaper is attached to the first metal frame using magnetic or a locking mechanism that allows the first piece of wallpaper to be detached from the first metal frame without using any tool.

15. The wallpaper set of claim 11, wherein the second piece of wallpaper is attached to the second metal frame using magnetic or a locking mechanism that allows the second piece of wallpaper to be detached from the second metal frame without using any tool.

16. The wallpaper set of claim 11, wherein the third piece of wallpaper is attached to the third metal frame using magnetic or a locking mechanism that allows the third piece of wallpaper to be detached from the third metal frame without using any tool.

17. The wallpaper set of claim 1, further comprises a fourth piece of wallpaper detachable to a fourth metal frame, wherein the fourth metal frame is attached to the room or office's ceiling.

18. A wallpaper set comprising:
a first piece of wallpaper attaches to a first metal frame using magnetic or a locking mechanism that allows the first piece of wallpaper to be detached from the first metal frame without using any tool;
a second piece of wallpaper attaches to a second metal frame using magnetic or a locking mechanism that allows the second piece of wallpaper to be detached from the second metal frame without using any tool;
a third piece of wallpaper attaches to a third metal frame using magnetic or a locking mechanism that allows the third piece of wallpaper to be detached from the third metal frame without using any tool;
wherein the first metal frame, the second metal frame and the third metal frame are attached to three walls of a cubicle, room or office;
wherein the first piece of wallpaper is connected to the second piece of wallpaper at one edge and second piece of wallpaper is connected to the third piece of wallpaper at another edge; and
wherein images of the first piece of wallpaper, second piece of wallpaper and third piece of wallpaper are designed in a way that they are visually connected with each other, making a user within the cubicle, room or office to feel physically being in an environment shown by the images.

19. The wallpaper set of claim 18, further comprises a fourth piece of wallpaper detachable to a fourth metal frame, wherein the fourth metal frame is attached to the room or office's ceiling.

20. The wallpaper set of claim 18, wherein the locking mechanism is clips, two sided tapes, or Velcro® tapes.
